(19) United States
(12) Patent Application Publication
(10) Pub. No.: US 2024/0221206 A1
(43) Pub. Date: Jul. 4, 2024

(54) PROCESSING SYSTEM AND DISPLAY METHOD

(71) Applicant: Roland DG Corporation, Hamamatsu-shi (JP)

(72) Inventors: Shinya YAMAMOTO, Hamamatsu-shi (JP); Motohiro IKEMURA, Hamamatsu-shi (JP); Hikaru HASEGAWA, Hamamatsu-shi (JP)

(21) Appl. No.: 18/389,858

(22) Filed: Dec. 20, 2023

(30) Foreign Application Priority Data
Dec. 28, 2022 (JP) 2022-211136

(51) Int. Cl. G06T 7/73

(52) U.S. Cl. CPC G06T 7/73; G06T 2207/30204

(57) ABSTRACT

A processing system includes a processing device including a support surface to support a processing target and including identification marks having a reference positional relationship, and a controller. The controller is configured or programmed to include an acquirer to acquire a captured image of the support surface captured by an imaging device and including the identification marks and the processing target supported by the support surface, an identifier to identify positions of the identification marks in an orientation of the captured image, a converter to convert the orientation of the captured image such that a positional relationship among the identification marks in the captured image becomes the reference positional relationship to provide a converted captured image, and a display controller to display the converted captured image and a processing image showing contents of processing to be performed on the processing target in an overlapping manner.

### CROSS REFERENCE TO RELATED APPLICATIONS

The present application claims priority to Japanese Patent Application No. 2022-211136 filed on Dec. 28, 2022, which is incorporated by reference in this example in its entirety.

### BACKGROUND OF THE INVENTION

### 1. Field of the Invention

The present invention relates to a processing system and a display method.

### 2. Description of the Related Art

For example, Japanese Laid-Open Patent Publication No. 2018-187915 discloses a three-dimensional printing system performing printing on a plurality of three-dimensional objects. The three-dimensional printing system includes a printing table on which the plurality of three-dimensional objects is to be placed and a detector detecting the position and the orientation of each of the three-dimensional objects on the printing table.

The printing table has reference marks formed thereon. The detector is movable in an XY direction above the printing table. The detector detects the reference marks when passing directly above the printing table to detect the position and the orientation of each of the three-dimensional objects. Based on the results of the detection provided by the detector, printing data corresponding to each of the three-dimensional objects is generated.

According to the three-dimensional printing system disclosed in Japanese Laid-Open Patent Publication No. 2018-187915, when the detector is to detect the reference marks, the position and in the orientation of the detector with respect to the printing table are always the same.

### SUMMARY OF THE INVENTION

The present inventor has conceived of putting no limitation on the position or the orientation of the detector with respect to the printing table when the reference marks are to be detected to properly identify the position and the orientation of a three-dimensional object.

Example embodiments of the present invention provide a processing system and a display method capable of properly identifying a position and an orientation of a processing target supported by a support surface, with no dependence on the position or the orientation of an imaging device with respect to the support surface, and capable of displaying the processing target.

A processing system according to an example embodiment of the present invention includes a processing device including a support table with a support surface to support a processing target and including a plurality of identification marks with a reference positional relationship, and a controller wherein the controller is configured or programmed to execute operations of an acquirer to acquire a captured image of the support surface captured by an imaging device and including the plurality of identification marks and the processing target supported by the support surface, an identifier to identify positions of the plurality of identification marks in an orientation of the captured image acquired by the acquirer, a converter to convert the orientation of the captured image such that a positional relationship among the plurality of identification marks in the captured image becomes the reference positional relationship to provide a converted captured image, and a display controller to display the converted captured image and a processing image showing contents of processing to be performed on the processing target in an overlapping manner.

According to the above-described processing system, it may possibly occur that an image of the support surface is captured by an imaging device at any of various positions, any of various orientations, and any of various angles with respect to the support surface. The positions of the plurality of identification marks with respect to the orientation of the captured image are identified, and the orientation of the captured image is converted such that the positional relationship among the plurality of identification marks in the captured image becomes the reference positional relationship and thus the converted captured image is created. Therefore, the positional relationship among the plurality of identification marks in the converted captured image is the reference positional relationship. The converted captured image and the processing image are displayed in an overlapping manner, so that the processing target supported by the support surface is displayed with the position and the orientation thereof being properly identified.

A display method according to another example embodiment of the present invention includes an image capturing step of capturing an image of a support surface of a support table included in a processing device, the support surface including a plurality of identification marks with a reference positional relationship and capable of supporting a processing target, the image including the plurality of identification marks and the processing target supported by the support surface, an acquisition step of acquiring a captured image captured in the image capturing step, an identification step of identifying positions of the plurality of identification marks in an orientation of the captured image acquired in the acquisition step, a conversion step of converting the orientation of the captured image such that a positional relationship among the plurality of identification marks in the captured image becomes the reference positional relationship to provide a converted captured image, and a display step of displaying the converted captured image and a processing image showing contents of processing to be performed on the processing target in an overlapping manner.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a conceptual view of a processing system according to an example embodiment of the present invention.

FIG. 2 is a perspective view of a printer.

FIG. 3 is a front view of the printer.

FIG. 4 is a schematic view showing a configuration of bottom surfaces of ink heads and light radiation devices.

FIG. 5 is a block diagram of the processing system according to an example embodiment of the present invention.

FIG. 6 is a plan view of a support surface of a support table.

FIG. 7 is a flowchart showing a procedure of a display method.

FIG. 8 shows an example of captured image.

FIG. 9 shows an example of converted captured image.

FIG. 10 shows an example of estimated captured image.

FIG. 11 shows the converted captured image and a printing image displayed in an overlapping manner.

FIG. 12 shows the converted captured image and an adjusted image displayed in an overlapping manner.

### DETAILED DESCRIPTION OF THE EXAMPLE EMBODIMENTS

Hereinafter, example embodiments of the present invention will be described with reference to the drawings. Needless to say, the example embodiments described below are not intended to specifically limit the present invention in any way. Elements and sites having identical functions bear identical reference signs, and overlapping descriptions will be omitted appropriately or simplified.

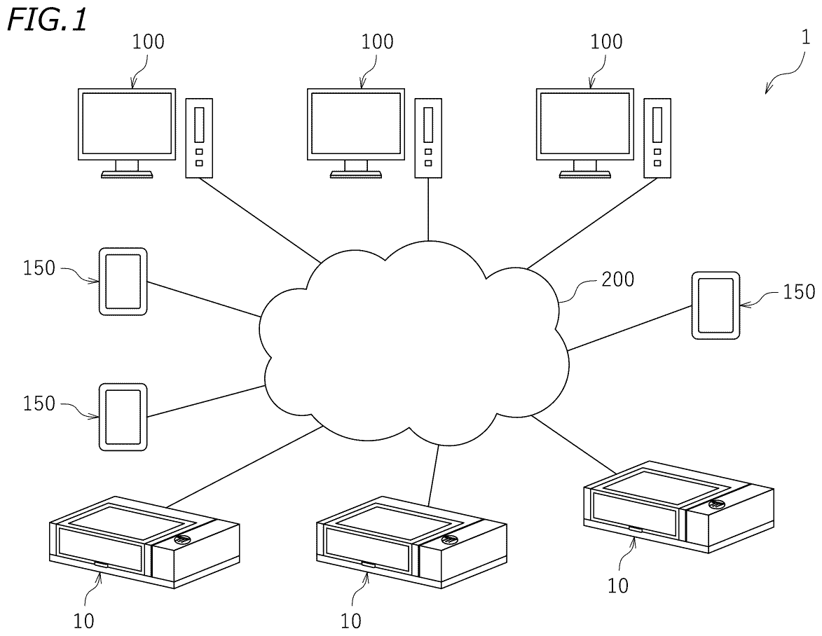

FIG. 1 is a conceptual view of a processing system 1 according to this example embodiment. As shown in FIG. 1, the processing system 1 includes printers 10, operational terminals 100, and imaging devices 150. The operational terminals 100 are communicably connected with the printers 10 and the imaging devices 150. In this example embodiment, the printers 10 are communicably connected with the imaging devices 150. Note that the printers 10 and the imaging devices 150 do not need to be communicably connected with each other. In this example embodiment, the printers 10, the operational terminals 100 and the imaging devices 150 are connected with the Internet 200, and are communicable with each other via the Internet 200. Hereinafter, the printers 10, the operational terminals 100 and the imaging devices 150 will be described sequentially.

First, the printers 10 will be described. In this example embodiment, the processing system 1 includes three printers 10, for example. There is no specific limitation on the number of the printer(s) 10.

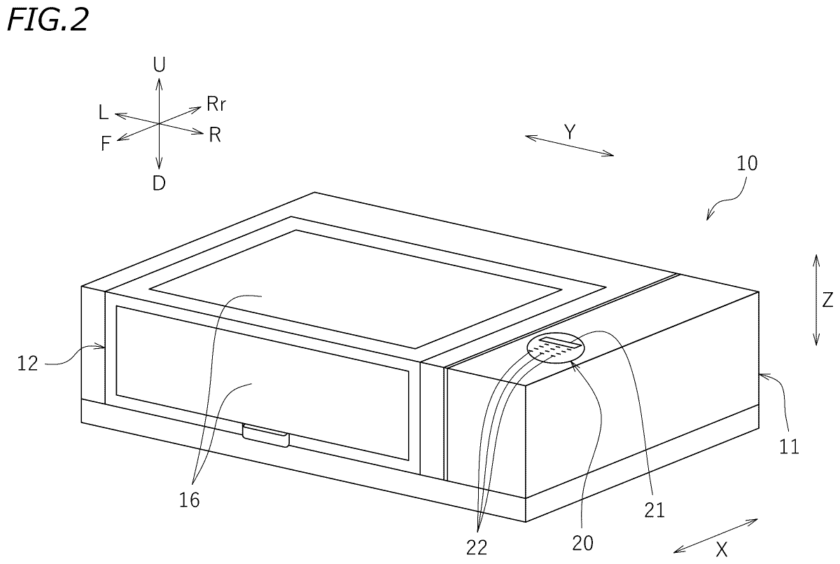

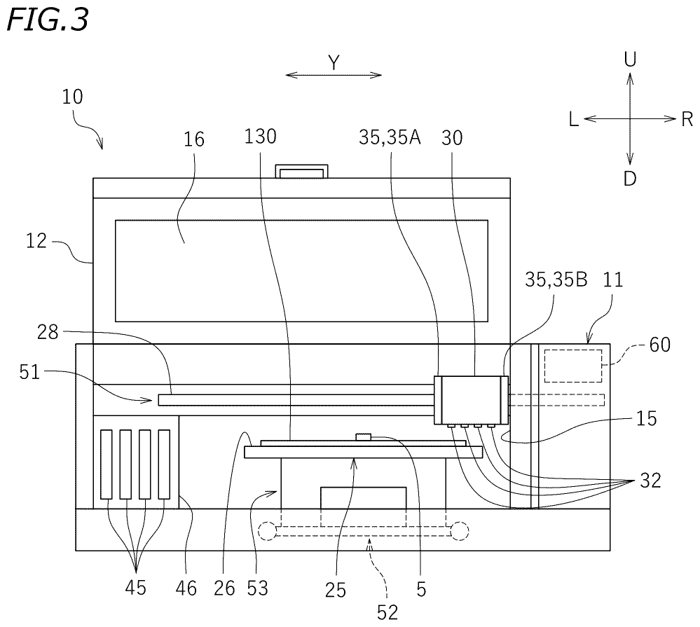

FIG. 2 is a perspective view of one printer 10. FIG. 3 is a front view of the printer 10. In the following description, in a state where a user faces the printer 10, a direction in which the user is separated farther away from the printer 10 will be referred to as “forward” or “front”, and a direction in which the user approaches the printer 10 will be referred to as “rearward” or “rear”. Left, right, up and down of the printer 10 respectively refer to left, right, up and down in the state where the user faces the printer 10. In the drawings, letters, F, Rr, L, R, U and D respectively represent front, rear, left, right, up and down of the printer 10. In the drawings, letter Y represents a main scanning direction. In this example, the main scanning direction Y is a left-right direction. Letter X represents a sub scanning direction. The sub scanning direction X crosses (in this example, perpendicularly crosses) the main scanning direction Y as seen in a plan view. The sub scanning direction X is, for example, a front-rear direction. Letter Z represents a height direction, in other words, an up-down direction. The height direction Z perpendicularly crosses the main scanning direction Y and the sub scanning direction X. Note that these directions are merely defined for the sake of convenience of description, and do not limit the manner of installation of the printer 10 in any way or do not limit the present invention in any way.

The printer 10 is an inkjet printer. Note that the printer 10 is not limited to being of any printing system. The printer 10 may be, for example, a dot impact printer, or may be a laser printer or a thermal printer. The printer 10 is a so-called flatbed printer, and is configured such that a support table 25 described below (see FIG. 3) moves in the sub scanning direction X and accordingly, a printing target 5 (see FIG. 3) also moves in the sub scanning direction X. Note that the printer 10 may be a so-called gantry printer, in which the printing target 5 supported by the support table 25 does not move, whereas ink heads 32 described below (see FIG. 3) move in the main scanning direction Y and the sub scanning direction X.

In this example embodiment, the printer 10 is an example of a processing device. The printer 10 processes the printing target 5, which is an example of a processing target. As used herein, “processing” refers to subjecting a surface of a processing target (in this example embodiment, the printing target 5) to some type of processing to change the surface. In this example embodiment, the printer 10 performs printing on a surface of the printing target 5 to change the surface. The printer 10 is a device that performs printing on the printing target 5 to process the printing target 5.

As shown in FIG. 2, the printer 10 includes a case-like printer body 11 and a cover 12. The printer body 11 is, for example, cuboid-shaped, and has an inner space. Printing is performed in the inner space. As shown in FIG. 3, the printer body 11 has an opening 15 formed in a front portion thereof.

The cover 12 is supported by the printer body 11 so as to open or close the opening 15. The cover 12 is rotatable about a rear end thereof, which acts as an axis of rotation. As shown in FIG. 2, the cover 12 includes windows 16 provided at a front surface and a top surface thereof. The windows 16 are each formed of a transparent or semi-transparent member, for example, an acrylic plate. The user visually recognizes the inner space of the printer body 11 through the windows 16.

In this example embodiment, as shown in FIG. 2, the printer 10 includes an operation panel 20. The operation panel 20 is provided in the printer body 11. In more detail, the operation panel 20 is provided in a right top portion of the printer body 11. There is no specific limitation on the position of the operation panel 20 with respect to the printer body 11. The operation panel 20 includes a display screen 21 displaying, for example, information on various settings on the printer 10, and operation keys 22. The user operates, for example, the operation keys 22 to cause information on various settings to be displayed on the display screen 21 or to determine contents of the settings. In this example embodiment, the operation keys 22 are physical buttons. Alternatively, the operation keys 22 may be realized by a touch panel provided on the display screen 21.

Now, an internal configuration of the printer 10 will be described. As shown in FIG. 3, the printer 10 includes the support table 25. The support table 25 supports the printing target 5. In this example, the support table 25 includes a support surface 26 supporting the printing target 5. The support surface 26 defines a top surface of the support table 25. The printing target 5 is placed on the support surface 26. In this example, printing is performed on the support surface 26. The support surface 26 is a flat surface expanding in the main scanning direction Y and the sub scanning direction X.

As shown in FIG. 3, the printer 10 includes a guide rail 28, a carriage 30, the ink heads 32, and light radiation devices 35. The guide rail 28 is located in the inner space of the printer body 11, and is secured to the printer body 11. The guide rail 28 is located above the support table 25. The guide rail 28 extends in the main scanning direction Y. The carriage 30 is slidable along the guide rail 28. The carriage 30 is movable in the main scanning direction Y along the guide rail 28.

The ink heads 32 are located above the support table 25. In this example, the ink heads 32 are located above the support table 25 and also above the printing target 5 supported by the support table 25. The ink heads 32 eject ink. In this example, the ink heads 32 eject ink downward toward the printing target 5 supported by the support table 25. The ink heads 32 are provided in the carriage 30. In more detail, the ink heads 32 are provided in the carriage 30 such that bottom surfaces thereof are exposed in a bottom surface of the carriage 30, and are supported by the carriage 30. There is no specific limitation on the number of the ink head(s) 32. In this example embodiment, there are four ink heads 32, for example. The four ink heads 32 are arranged a line in the main scanning direction Y.

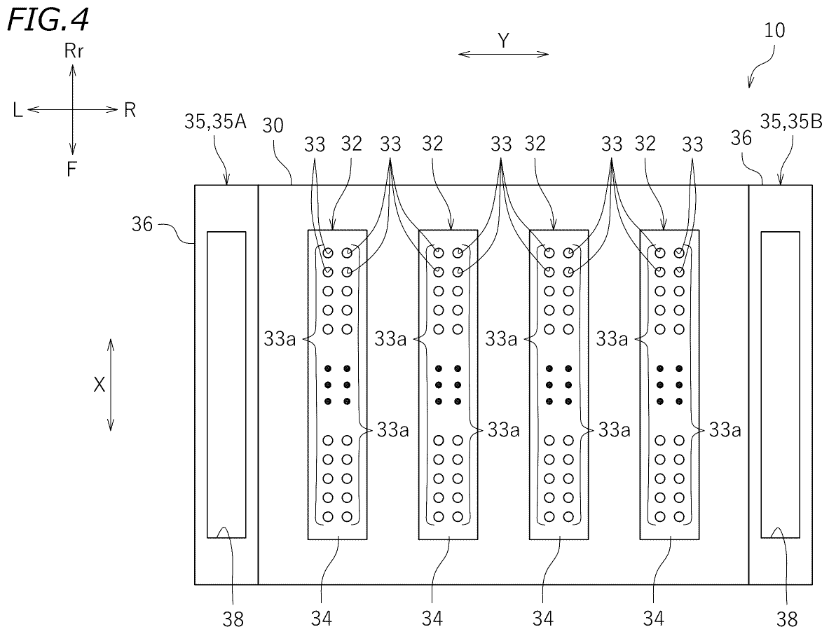

FIG. 4 is a schematic view showing a configuration of the bottom surfaces of the ink heads 32 and bottom surfaces of the light radiation devices 35. In this example embodiment, as shown in FIG. 4, the ink heads 32 each include a plurality of nozzles 33 and a nozzle surface 34, in which the plurality of nozzles 33 are provided. The nozzle surface 34 defines the bottom surface of the ink head 32. In each ink head 32, the plurality of nozzles 33 are linearly arranged in the sub scanning direction X. In this example, regarding each ink head 32, a line of a plurality of nozzles 33 arranged in the sub scanning direction X will be referred to as a “nozzle line 33a”. In this example embodiment, each ink head 32 includes two nozzle lines 33a. Alternatively, each ink head 32 may include one nozzle line 33a, or three or more nozzle lines 33a.

The ink heads 32 eject ink of different colors respectively. There is no specific limitation on the specific color ejected from each ink head 32. The ink to be ejected from each ink head 32 is of any of colors of, for example, process color ink or special ink color. The process color ink includes cyan ink, magenta ink, yellow ink, black ink, and the like. The special color ink includes ink of colors other than those of the process color ink, for example, white ink, clear ink, and the like. In this example embodiment, the plurality of ink heads 32 eject ink of different colors respectively. Alternatively, some of the ink heads 32 may eject ink of the same color. For example, two ink heads 32 may eject ink of the same color. Alternatively, the nozzle lines 32a of one ink head 32 may eject ink of different colors.

There is no specific limitation on the material of the ink to be ejected from the ink heads 32. Any of various types of materials conventionally used as the materials of ink of inkjet printers is usable. In this example embodiment, the ink to be ejected from the ink heads 32 is photocurable ink, which is progressively cured when being irradiated with light. Light to be radiated toward the ink is, for example, ultraviolet rays. In this example, the ink is ultraviolet-curable ink, which is progressively cured when being irradiated with ultraviolet rays.

In this example embodiment, the ink to be ejected from the ink heads 32 is accommodated in ink cartridges 45 shown in FIG. 3. For example, a housing 46 is located in a left front portion of the printer body 11. The ink cartridges 45 are accommodated in the housing 46. For example, one ink cartridge 45 is connected with one ink head 32. Each of the ink cartridges 45 is connected with the corresponding ink head 32 via, for example, an ink tube (not shown). The ink accommodated in each of the ink cartridges 45 is supplied to the ink head 32 via the ink tube.

The light radiation devices 35 radiate light. In this example embodiment, the light radiation devices 35 radiate light toward the ink ejected from the ink heads 32. In more detail, the light radiation devices 35 radiate light toward the ink ejected onto the printing target 5 supported by the support table 25. In this example embodiment, the ink ejected from the ink heads 32 (more specifically, the nozzles 33) is ultraviolet-curable ink, which is progressively cured when being irradiated with ultraviolet rays. Therefore, the light radiation devices 35 may each be an ultraviolet radiation device that radiates ultraviolet rays toward the ink ejected from the ink heads 32.

As shown in FIG. 3, the light radiation devices 35 are provided on the carriage 30, and are movable in the main scanning direction Y together with the carriage 30 and the ink heads 32. In this example embodiment, there are two light radiation devices 35. The light radiation devices 35 include a first light radiation device 35A provided to the left of the carriage 30 and a second light radiation device 35B provided to the right of the carriage 30. The light radiation devices 35 are provided to the left of, and to the right of, the carriage 30, that is, to the left of, and to the right of, the ink heads 32. Either the first light radiation device 35A or the second light radiation device 35B may be omitted. There may be one light radiation device 35, or three or more light radiation devices 35. In this example, the light radiation devices 35 are located side by side with the ink heads 32 in the main scanning direction Y.

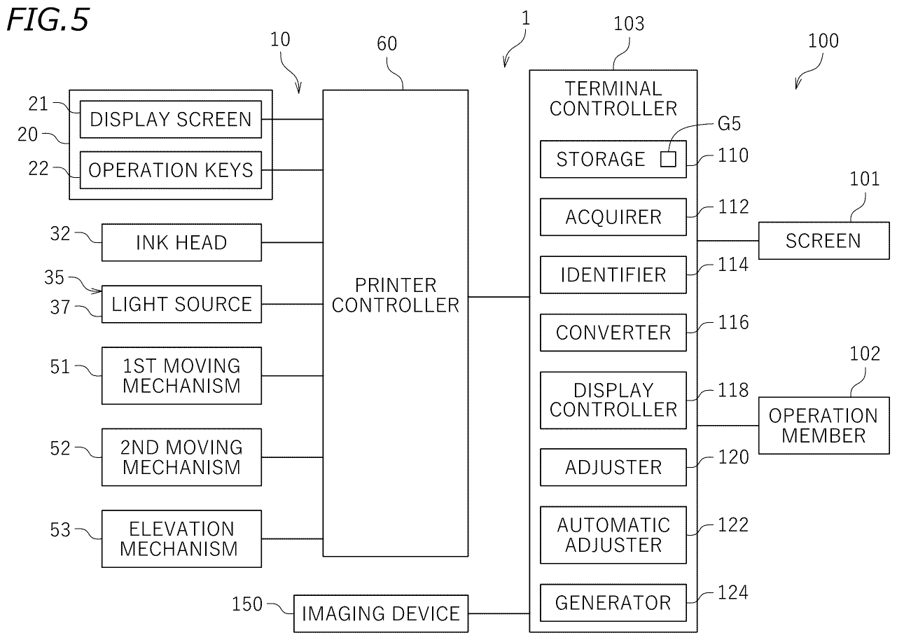

FIG. 5 is a block diagram of the processing system 1 according to this example embodiment. In this example embodiment, the light radiation devices 35 each include a radiation body 36 (see FIG. 4) and a light source 37 (see FIG. 5). The radiation body 36 is, for example, cuboid-shaped, and is hollow. As shown in FIG. 4, the radiation bodies 36 each have a radiation opening 38 formed in a bottom surface thereof. The radiation opening 38 is quadrangular in this example, but is not limited to having any specific shape. The light source 37 shown in FIG. 5 emits light (in this example, ultraviolet rays), and is located inside each of the radiation bodies 36. The light emitted from the light source 37 passes through the radiation opening 38 and is radiated toward the ink ejected onto the printing target 5 supported by the support table 25.

In this example embodiment, as shown in FIG. 3, the printer 10 includes a first moving mechanism 51 moving the carriage 30, the ink heads 32 and the light radiation devices 35 in the main scanning direction Y with respect to the support table 25, and a second moving mechanism 52 moving the printing target 5 supported by the support table 25 in the sub scanning direction X with respect to the carriage 30, the ink heads 32 and the light radiation devices 35. The printer 10 further includes an elevation mechanism 53 to elevate the support table 25 up and down, although a configuration thereof will not be described in detail.

The first moving mechanism 51 moves the carriage 30, the ink heads 32 and the light radiation devices 35 in the main scanning direction Y. There is no specific limitation on the configuration of the first moving mechanism 51. The first moving mechanism 51 includes, for example, left and right pulleys, a belt and a scan motor, although these elements are not shown in the figures. The left pulley is provided in the vicinity of a left end of the guide rail 28, and the right pulley is provided in the vicinity of a right end of the guide rail 28. The belt is, for example, an endless belt, and is wound along the left and right pulleys. The carriage 30 is attached and secured to the belt. The scan motor is connected to one of the left and right pulleys. In this example, the scan motor is driven to rotate the pulleys, so that the belt runs between the left and right pulleys. As a result, the ink heads 32 and the light radiation devices 35 move, together with the carriage 30, in the main scanning direction Y along the guide rail 28.

The second moving mechanism 52 moves the support table 25 in the sub scanning direction X, and accordingly, moves the printing target 5 supported by the support table 25 in the sub scanning direction X. There is no specific limitation on the configuration of the second moving mechanism 52. In this example, the second moving mechanism 52 includes a support table carriage that supports the support table 25, and a pair of (more specifically, left and right) slide rails that support the support table carriage such that the support table carriage is slidable and that extend in the sub scanning direction X, although these elements of the second moving mechanism 52 are not shown in the figures. The second moving mechanism 52 further includes a pair of (more specifically, front and rear) slide pulleys provided to the front of, and to the rear of, the slide rails, and a slide belt wound along the front and rear slide pulleys, although these elements of the second moving mechanism 52 are not shown in the figures. The support table carriage is secured to the slide belt. A feed motor is connected to one of the front and rear slide pulleys. In this example, the feed motor is driven to run the slide belt, so that the support table 25 moves, together with the support table carriage, in the sub scanning direction X. As a result, the printing target 5 supported by the support table 25 also moves in the sub scanning direction X.

As shown in FIG. 3, the printer 10 includes a printer controller 60. The printer controller 60 is configured or programmed to perform, for example, control on printing. There is no specific limitation on the configuration of the printer controller 60. The printer controller 60 is, for example, a microcomputer. There is no specific limitation on the hardware configuration of the microcomputer. The printer controller 60 includes, for example, an interface (I/F) to receive printing data or the like from an external device such as a host computer or the like, a central processing unit (CPU) to execute commands of a control program, a ROM (Read Only Memory) to store a program to be executed by the CPU, a RAM (Random Access Memory) used as a working area where the program is developed, and a memory to store the above-mentioned programs and various types of data. The printer controller 60 is provided inside the printer body 11. Note that the printer controller 60 may be realized by, for example, a computer installed outside the printer body 11. In this case, the printer controller 60 may be communicably connected with a control substrate (not shown) of the printer 10 in a wired or wireless manner.

In this example embodiment, as shown in FIG. 5, the printer controller 60 is communicably connected with the operation panel 20 (more specifically, the display screen 21 and the operation keys 22), the ink heads 32, the light radiation devices 35 (more specifically, the light sources 37), the first moving mechanism 51, the second moving mechanism 52 and the elevation mechanism 53. The printer controller 60 controls the control panel 20, the ink heads 32, the light radiation devices 35, the first moving mechanism 51, the second moving mechanism 52 and the elevation mechanism 53.

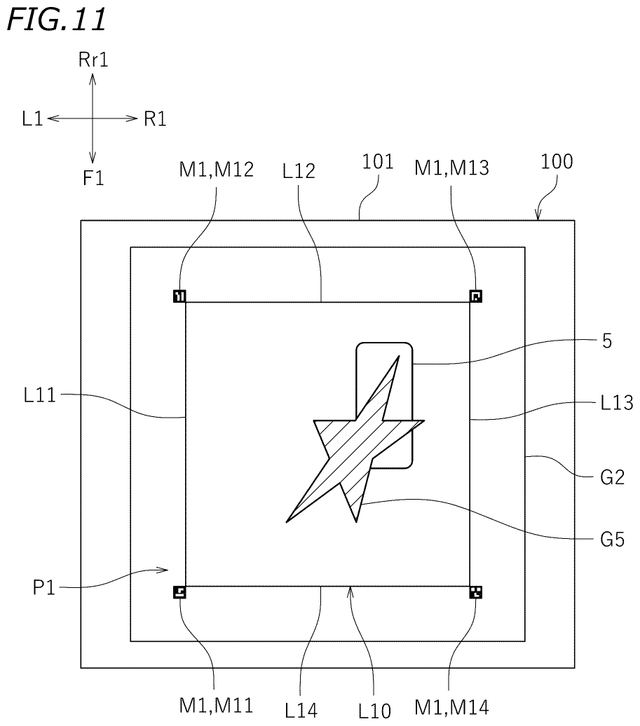

The configuration of the printer 10 according to this example embodiment is described above. Now, the operational terminals 100 shown in FIG. 1 will be described. The operational terminals 100 are each operable by the user. The user operates the operational terminal 100 to control the printer 10. The operational terminal 100 is also usable to create an image to be printed on the printing target 5 (e.g., a printing image G5 described below (see FIG. 11)), to set the position of the printing target 5, on which the image is to be printed, or to set the size or the orientation of the image with respect to the printing target 5.

In this example embodiment, as shown in FIG. 1, each of the operational terminals 100 is communicably connected with the corresponding printer 10 via the Internet 200. The operational terminal 100 is realized by, for example, a computer installed outside the printer body 11 of the printer 10. The computer realizing the operational terminal 100 may be a computer exclusively usable for the printer 10 or a general-purpose computer. The operational terminal 100 may be a desk-top computer or a laptop computer. The operational terminal 100 may be a tablet terminal or a smartphone. In this example embodiment, the processing system 1 includes three operational terminals 100. There is no specific limitation on the number of the operational terminal(s) 100.

As shown in FIG. 5, the operational terminal 100 includes a screen 101, an operation member 102, and a terminal controller 103. The screen 101 is, for example, a screen of a desk-top or laptop computer, or a screen of a mobile terminal such as a tablet terminal, a smartphone or the like. The operation member 102 is usable by the user to input information. The operation member 102 is formed of, for example, a keyboard, a mouse, a touch panel or the like. The terminal controller 103 includes, for example, a CPU, a ROM, a RAM and the like. The terminal controller 103 is communicably connected with the screen 101 and the operation member 102. The terminal controller 103 is further connected with the Internet 200 and is communicably connected with the printer 10 (more specifically, the printer controller 60) via the Internet 200.

The printing target 5 (see FIG. 3), which is a target on which the printer 10 according to this example embodiment is to perform printing, is a three-dimensional object. The printing target 5 is, for example, a component to be used as a smartphone case. The printing target 5 is formed of a resin. There is no specific limitation on the type of the material forming the printing target 5. The printing target 5 may be, for example, a planar object formed of paper or the like. The printing target 5 may be a sheet formed of a resin material such as PCV, polyester or the like, or a relatively thick object such as a metal plate, a glass plate, a wooden plate or the like.

As shown in FIG. 3, when printing is to be performed on the printing target 5, the printing target 5 is placed on the support surface 26 of the support table 25. Conventionally, at this point, the printing target 5 is placed on the support surface 26 at a reference position and a reference orientation with respect to the support surface 26. If the printing target 5 is placed on the support surface 26 at a position and an orientation deviated from the reference position and the reference orientation, the position and the orientation of an image printed on the printing target 5 may undesirably be deviated from the intended position or orientation. Therefore, conventionally, for example, a special jig having a fitting hole to which the printing target 5 is to be fitted is located on the support surface 26, or the position and the orientation at which the printing target 5 is to be placed are marked on the support surface 26, so that the printing target 5 is placed at the reference position and the reference orientation. In such a case, the user needs to pay attention to the position and the orientation of the printing target 5 when placing the printing target 5 which may be difficult or disturbing for the user. Therefore, in this example embodiment, an image printed on the printing target 5 is prevented from being easily deviated even if the user places the printing target 5 freely on the support surface 26, for example, even if the user does not place the printing target 5 at the reference position or the reference orientation.

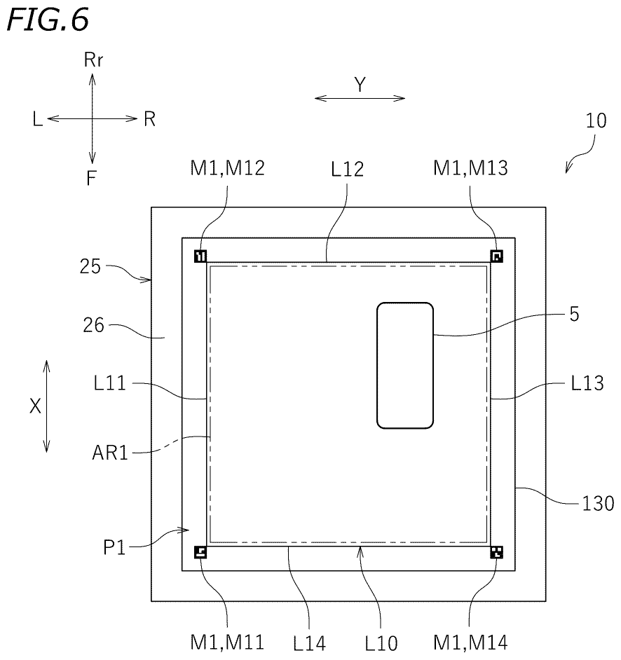

FIG. 6 is a plan view showing the support surface 26 of the support table 25. In this example embodiment, as shown in FIG. 6, a printing range AR1 is preset on the support surface 26 of the support table 25. The printing range AR1 is an example of a processing range. The printing range AR1 is a range where the printing target 5 is to be processed. In this example, the printing range AR1 is a range where it is possible to perform printing on the printing target 5, and a range where the printing target 5 is to be placed on the support surface 26. The printing range AR1 is, for example, rectangular, but is not limited to being of any specific shape. (In this specification, “rectangular” encompasses square.)

In this example embodiment, the support surface 26 includes a plurality of identification marks M1 provided thereon. In this example embodiment, the identification marks M1 are to identify the position of the printing range AR1 with respect to the support surface 26. There is no specific limitation on the number of the identification mark(s) M1, but the number of the identification marks M1 is, for example, three or greater. In this example, there are four identification marks M1. The four identification marks M1 are provided at positions corresponding to the printing range AR1. In this example, the four identification marks M1 are provided at positions, of the support surface 26, corresponding to vertices of the rectangular printing range AR1. Note that the plurality of identification marks M1 do not need to be provided at the positions corresponding to the printing range AR1. For example, the plurality of identification marks M1 may be provided in a partial range in the rectangular printing range AR1 (e.g., a range not including the vertices of the printing range AR1). The plurality of identification marks M1 may be provided in a range outside the printing range AR1. Alternatively, among the plurality of identification marks M1, a portion thereof may be provided in the printing range AR1, whereas another portion thereof may be provided in a range outside the printing range AR1.

In this example, the four identification marks M1 will be referred to as a first identification mark M11, a second identification mark M12, a third identification mark M13 and a fourth identification mark M14. The identification marks M1 include the first identification mark M11, the second identification mark M12, the third identification mark M13 and the fourth identification mark M14. The first identification mark M11, the second identification mark M12, the third identification mark M13 and the fourth identification mark M14 are respectively provided at a left front vertex, a left rear vertex, a right rear vertex and a right front vertex of the printing range AR1. The first identification mark M11 through the fourth identification mark M14 respectively include information on the positions thereof with respect to the printing range AR1. An image of the first identification mark M11 through the fourth identification marks M14 may be captured by the imaging device 150 (see FIG. 1), so that the operational terminal 100 can determine the position at which each of the identification marks M1 is located. For example, the first identification mark M11 includes information on the position at the left front vertex of the printing range AR1. As a result of an image of the first identification mark M11 being captured by the imaging device 150, the operational terminal 100 can determine the position of the left front vertex of the printing range AR1 from the first identification mark M11.

In this example embodiment, the positional relationship among the plurality of identification marks M1 provided on the support surface 26 will be referred to as a “reference positional relationship P1”. The reference positional relationship P1 refers to the positional relationship among the first identification mark M11 through the fourth identification mark M14. In this example, the reference positional relationship P1 is the positional relationship among the plurality of identification marks M1 in a state where the first identification mark M11, the second identification mark M12, the third identification mark M13 and the fourth identification mark M14 are respectively located at the left front vertex, the left rear vertex, the right rear vertex and the right front vertex of the support surface 26. For example, the reference positional relationship P1 of the first identification mark M11 is to the front of the second identification mark M12, to the front and the left of the third identification mark M13, and to the left of the fourth identification mark M14.

There is no specific limitation on the type or the shape of the identification marks M1. In this example, the identification marks M1 include, so-called AR markers or ArUco markers. The identification marks M1 are, for example, rectangular.

In this example embodiment, the support surface 26 includes a frame border line L10 provided thereon, in addition to the identification marks M1. The frame border line L10 is a line connecting the plurality of identification marks M1 to each other. The frame border line L10 extends along an outer contour of the printing range AR1, and defines a rectangular or substantially rectangular shape. The frame border line L10 encloses the printing range AR1 as seen in a plan view. In this example, the frame border line L10 includes a first frame border line L11 connecting the first identification mark M11 and the second identification mark M12, a second frame border line L12 connecting the second identification mark M12 and the third identification mark M13, a third frame border line L13 connecting the third identification mark M13 and the fourth identification mark M14, and a fourth frame border line L14 connecting the fourth identification mark M14 and the first identification mark M11. The first frame border line L11 and the third frame border line L13 are parallel to each other, and the second frame border line L12 and the fourth frame border line L14 are parallel to each other. In this example embodiment, the frame border line L10 connects corners of the first identification mark M11 through the fourth identification mark M14, closest to the center of the printing range AR1. In more detail, the frame border line L10 connects the right rear corner of the first identification mark M11, the right front corner of the second identification mark M12, the left front corner of the third identification mark M13 and the left rear corner of the fourth identification mark M14. Regarding the frame border line L10 connecting the first identification mark M11 through the fourth identification mark M14, there is no specific limitation on which positions in the first identification mark M11 through the fourth identification mark M14 are to be connected. For example, the frame border line L10 may connect the central points of the first identification mark M11 through the fourth identification mark M14. Alternatively, the frame border line L10 may connect corners of the first identification mark M11 through the fourth identification mark M14, farthest from the center of the printing range AR1. The frame border line L10 may be omitted.

In this example embodiment, the plurality of identification marks M1 are provided on the support surface 26. As used herein, the expression “the identification marks M1 are provided on the support surface 26” refers to a state where the identification marks M1 are located on the support surface 26 and the positional relationship among the plurality of identification marks M1 (in this example, the first identification mark M11 through the fourth identification mark M14) is identifiable. Regarding the expression “provided” regarding the identification marks M1, the identification marks M1 may be provided by being printed, or may be provided by being pasted like an adhesive seal, for example. The plurality of identification marks M1 may be directly provided on the support surface 26, or provided on another member and indirectly provided on the support surface 26 via the another member. The frame border line L10 may be directly provided on the support surface 26, or provided on another member and indirectly provided on the support surface 26 via the another member.

In this example embodiment, as shown in FIG. 3, the support table 25 includes a carrying jig 130. When, for example, printing is to be performed on the printing target 5, the carrying jig 130 is placed on the support surface 26 of the support table 25, and thus is supported by the support surface 26. As shown in FIG. 6, the carrying jig 130 is placed so as to cover the printing range AR1 of the support surface 26 from above. On the carrying jig 130, the printing target 5 is placed. The carrying jig 130 supports the printing target 5. In this example, when printing is to be performed on the printing target 5, the printing target 5, the carrying jig 130 and the support surface 26 are stacked in this order from top to bottom. There is no specific limitation on the number of the printing target(s) 5 supported by the carrying jig 130, that is, the number of the printing target(s) 5 supported by the support surface 26. In FIG. 6, one printing target 5 is placed on the printing range AR1 of the support surface 26. There is no specific limitation on the number of such printing target(s) 5.

The carrying jig 130 is a plate-shaped structure. In this example, the carrying jig 130 is a plate-shaped structure that expands in the main scanning direction Y and the sub scanning direction X and has a size in the thickness direction Z shorter than sizes thereof in the main scanning direction Y and the sub scanning direction X. The carrying jig 130 is cuboid-shaped, and is rectangular or substantially rectangular as seen in a plan view. Note that there is no specific limitation on the shape of the carrying jig 130. There is no specific limitation on the material forming the carrying jig 130. The carrying jig 130 is formed of, for example, rubber. With such a material, when the printing target 5 is placed on the carrying jig 130, the printing target 5 is prevented from slipping with respect to the carrying jig 130, and in addition, the carrying jig 130 is also prevented from slipping with respect to the support surface 26. At least a surface of the carrying jig 130 on which the printing target 5 is to be placed (in this example, a top surface of the carrying jig 130) is black. For example, the carrying jig 130 is entirely black. The carrying jig 130 may be made black like this, so that, for example, light from the light radiation devices 35 (see FIG. 3) is difficult to be reflected by the carrying jig 130. Note that there is no specific limitation on the color of the carrying jig 130.

In this example embodiment, as shown in FIG. 6, the carrying jig 130 includes the plurality of identification marks M1 (in this example, the first identification mark M11 through the fourth identification mark M14) and the frame border line L10 provided thereon. In more detail, in a state where the carrying jig 130 is placed on the support surface 26, the plurality of identification marks M1 are provided at positions, of the carrying jig 130, corresponding to the positions of the vertices of the printing range AR1. The frame border line L10 is provided on the carrying jig 130 so as to connect the plurality of identification marks M1 on the carrying jig 130. In this example, the plurality of identification marks M1 and the frame border line L10 are provided on the carrying jig 130 by being printed. In this example embodiment, the carrying jig 130 is placed on the support surface 26 such that the positional relationship among the plurality of identification marks M1 provided on the carrying jig 130 is the reference positional relationship P1, and the frame border line L10 encloses the printing range AR1 as seen in a plan view. There is no specific limitation on the color of the identification marks M1 or on the color of the frame border line L10. The identification marks M1 and the frame border line L10 are, for example, black. Note that in the case where the carrying jig 130 is black, the identification marks M1 and the frame border line L10 are, for example, white.

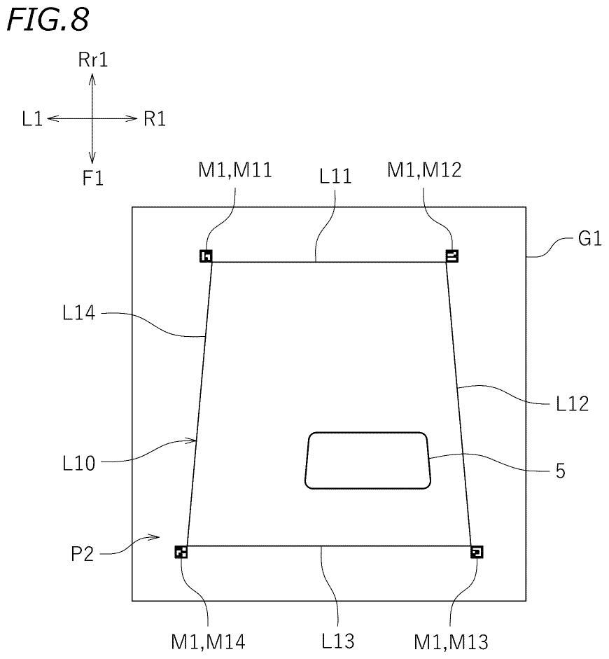

The imaging devices 150 shown in FIG. 1 are each usable by, for example, the user. The imaging device 150 captures an image of the support surface 26 of the support table 25. The user uses the imaging device 150 to capture an image of the support surface 26 such that the plurality of identification marks M1 and the frame border line L10 provided on the support surface 26 and the printing target 5 supported by the support table 26 are in the image. An image of the support table 26 captured by the imaging device 150 in this manner is referred to as a “captured image G1” (see FIG. 8).

In this example embodiment, as shown in FIG. 1, the processing system 1 includes three imaging devices 150. There is no specific limitation on the number of the imaging device(s) 150. There is no specific limitation on the type of the imaging device(s) 150. The imaging device 150 may be of any type that allows the operational terminal 100 to determine the positional relationship among the plurality of identification marks M1 by capturing an image thereof. The imaging device 150 is, for example, a camera. The imaging device 150 is a camera mounted on a mobile terminal such as a smartphone, a tablet terminal or the like. The imaging device 150 is separate from the operational terminal 100, and is communicable with the operational terminal 100 via, for example, the Internet 200. Note that the imaging device 150 may be mounted on the operational terminal 100, that is, may be formed integrally with the operational terminal 100. In this example embodiment, the imaging device 150 is not secured to the printer 10 (e.g., the printer body 11 or the carriage 30 (see FIG. 3)). Therefore, the position of the imaging device 150 with respect to the support surface 26 is not fixed, and may be determined by the user. That is, the user may use the imaging device 150 to capture an image of the support surface 26 at any orientation, in any direction or from any position.

In this example embodiment, in the processing system 1, the operational terminal 100 acquires a captured image G1 captured by the imaging device 150, determines the size, the orientation, the position and the like of a printing image to be printed on the printing target 5 based on the captured image G1, and thus generates printing data for printing. The operational terminal 100 transmits the printing data to the printer 10, and the printer 10 prints the printing image on the printing target 5 based on the printing data. This will be described in more detail below.

In this example embodiment, the terminal controller 103 of the operational terminal 100 is an example of controller. As shown in FIG. 5, the terminal controller 103 of the operational terminal 100 is configured or programmed to include a storage 110, an acquirer 112, an identifier 114, a converter 116, a display controller 118, an adjuster 120, an automatic adjuster 122, and a generator 124. The terminal controller 103 is configured or programmed to execute operations of the storage 110, the acquirer 112, the identifier 114, the converter 116, the display controller 118, the adjuster 120, the automatic adjuster 122 and the generator 124. Each of these elements of the terminal controller 103 may include software and/or hardware. For example, each of the elements of the terminal controller 103 may be realized by a plurality of processors, or may be incorporated into a circuit.

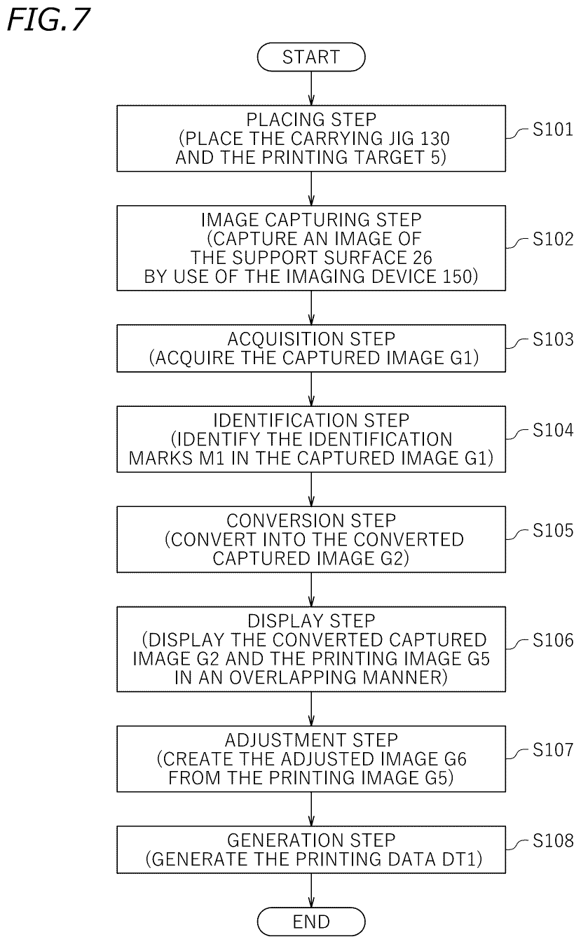

Now, a display method according to this example embodiment will be described with reference to FIG. 7, which is a flowchart. In this example, as shown in FIG. 7, the display method includes a placing step S101, an image capturing step S102, an acquisition step S103, an identification step S104, a conversion step S105, a display step S106, an adjustment step S107, and a generation step S108.

First, in the placing step S101, as shown in FIG. 3, the printing target 5 is placed on the support surface 26 of the support table 25 of the printer 10, so that the support surface 26 supports the printing target 5. In this example, the user places the carrying jig 130 on the support surface 26, and places the printing target 5 on the carrying jig 130. As shown in FIG. 6, the printing range AR1 is preset on the support surface 26. Therefore, the user places the carrying jig 130 on the support surface 26 such that the plurality of identification marks M1 provided on the carrying jig 130 positionally overlap the vertices of the printing range AR1 as seen in a plan view. At this point, the user orients the carrying jig 130 on the support surface 26 such that the first identification mark M11, the second identification mark M12, the third identification mark M13 and the fourth identification mark M14 are respectively located at the left front vertex, the left rear vertex, the right rear vertex and the right front vertex of the printing range AR1. In other words, the user places the carrying jig 130 on the support surface 26 such that the positional relationship among the plurality of identification marks M1 is the reference positional relationship P1.

Then, the user places the printing target 5 on the carrying jig 130. At this point, there is no specific limitation on the orientation of the printing target 5 with respect to the support surface 26 (in other words, the carrying jig 130). In the example of FIG. 6, one printing target 5 is placed on the carrying jig 130. Alternatively, a plurality of printing targets 5 may be placed on the carrying jig 130. In the case where a plurality of printing targets 5 are placed on the carrying jig 130, the plurality of printing targets 5 may be in the same orientation or different orientations. The user places the printing target 5 on the carrying jig 130 such that the printing target 5 is contained inside the frame border line L10 on the carrying jig 130 without protruding outside the frame border line L10. In this manner, the printing target 5 is located inside the printing range AR1.

Next, in the image capturing step S102 in FIG. 7, an image of the support surface 26 is captured by the imaging device 150. In this example, the user uses the imaging device 150 to capture an image of the support surface 26 such that the plurality of identification marks M1 (more specifically, the first identification mark M11 through the fourth identification mark M14) and the printing target 5 supported by the support surface 26 are in the image. FIG. 8 shows an example of the captured image G1. In FIG. 8 through FIG. 12, the carrying jig 130 is not shown. The captured image G1 shown in FIG. 8 is the image of the support surface 26 captured by the imaging device 150.

The imaging device 150 is not limited to being located at any specific position with respect to the support surface 26 when capturing an image of the support surface 26. For example, the user may capture an image of the support surface 26 from directly above the support surface 26, or from a position to the front of, and above, the support surface 26. That is, the user may capture an image of the support surface 26 in a direction perpendicular to the support surface 26 (in this example, in the height direction Z) or in a direction inclined by a predetermined angle from the height direction Z. The captured image G1 of the support surface 26 shown in FIG. 8 is an image captured from a position to the right of, and above, the support surface 26 by use of the imaging device 150. The captured image G1 of the support surface 26 captured by the imaging device 150 is stored on the imaging device 150.

Next, in the acquisition step S103 shown in FIG. 7, the captured image G1 captured by the imaging device 150 is acquired. In this example embodiment, the acquisition step S103 is realized by the acquirer 112 (see FIG. 5) of the operational terminal 100. The acquirer 112 acquires the captured image G1 from the imaging device 150. In this example embodiment, as shown in FIG. 1, the operational terminal 100 and the imaging device 150 are communicably connected with each other via the Internet 200. After being captured by the imaging device 150, the captured image G1 of the support surface 26 is transmitted to the operational terminal 100 via the Internet 200. The captured image G1 may be automatically transmitted to the operational terminal 100 at the time when being captured by the imaging device 150. Alternatively, for example, the imaging device 150, upon receipt of an acquisition signal transmitted from the operational terminal 100, may transmit the captured image G1 to the operational terminal 100. In the case where the operational terminal 100 and the imaging device 150 are formed integrally with each other, the captured image G1 is acquired by the acquirer 112 without the Internet 200. The acquirer 112 acquires the captured image G1 transmitted from the imaging device 150. The captured image G1 acquired by the acquirer 112 is stored on the storage 110 shown in FIG. 5.

Next, in the identification step S104 in FIG. 7, the positions of the plurality of identification marks M1 with respect to the orientation of the captured image G1 acquired in the acquisition step S103 (in this example, the orientation in FIG. 8) are identified. In this example embodiment, the identification step S104 is realized by the identifier 114 (see FIG. 5) of the operational terminal 100. The identifier 114 identifies the positions of the plurality of identification marks M1, that is, the first identification mark M11 through the fourth identification mark M14 with respect to the orientation of the captured image G1 acquired by the acquirer 112.

In this example, as shown in FIG. 8, the positional relationship among the plurality of identification marks M1 in the captured image G1 may possibly not be the reference positional relationship P1 (see FIG. 6). In FIG. 8 and the like, reference signs F1, Rr1, L1 and R1 respectively represent front, rear, left and right in the image (e.g., captured image G1). The identifier 114 identifies whether each of the first identification mark M11 through the fourth identification mark M14 is at the front, at the rear, at the left, or at the right in the orientation of the captured image G1. As described above, the identification marks M1 include, for example, AR markers. The terminal controller 103 of the operational terminal 100 has an AR marker application, capable of reading the AR markers, installed therein in advance. The identifier 114 uses the AR marker application to read the identification marks M1, and thus identifies the positions of the identification marks M1. In the example of FIG. 8, the first identification mark M11, the second identification mark M12, the third identification mark 13 and the fourth identification mark M14 are respectively located in a left rear position, at a right rear position, at a right front position, and at a left front position in the orientation of the captured image G1. In this example embodiment, the positional relationship among the plurality of identification marks M1 with respect to the orientation of the captured image G1 will be referred to as a “captured positional relationship P2”.

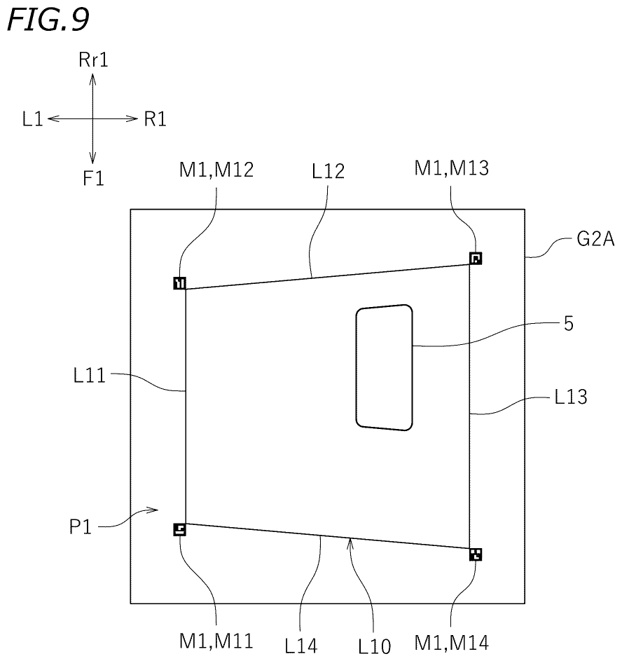

FIG. 9 shows an example of converted captured image G2A. In the next conversion step S105, the captured image G1 is converted into the converted captured image G2A (see FIG. 9). In this example embodiment, the conversion step S105 is realized by the converter 116 (see FIG. 5) of the operational terminal 100. The converter 116 converts the orientation of the captured image G1 such that the positional relationship among the plurality of identification marks M1 in the captured image G1 in FIG. 8 (in this example, the captured positional relationship P2) becomes the reference positional relationship P1 (see FIG. 6), and thus provides the converted captured image G2A shown in FIG. 9. In this example, the converter 116 rotates the captured image G1 such that the first identification mark M11, the second identification mark M12, the third identification mark M13 and the fourth identification mark M14 are located at a left front position, at a left rear position, at a right rear position, and at a right front position in the captured image G1, and thus provides the converted captured image G2A. In FIG. 9, the first identification mark M11, the second identification mark M12, the third identification mark M13 and the fourth identification mark M14 are respectively located at a left front position, at a left rear position, at a right rear position, and at a right front position in the converted captured image G2A, and thus have the reference positional relationship P1.

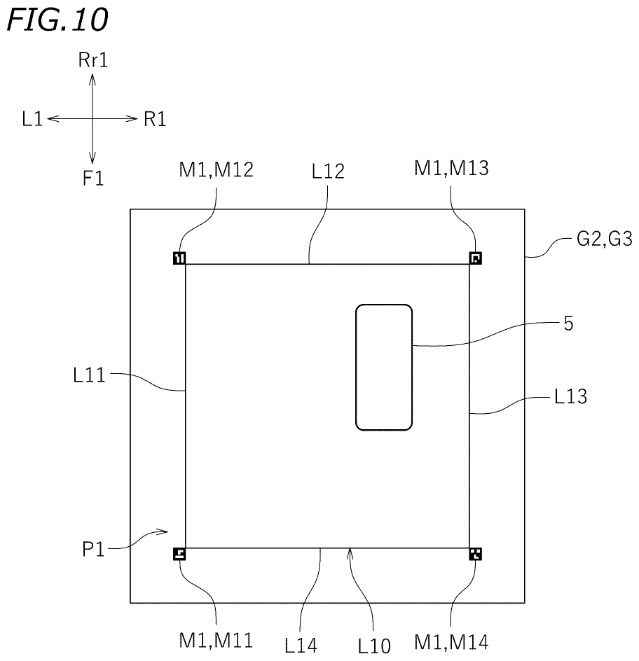

FIG. 10 shows an example of estimated captured image G3. In the conversion step S105, the converter 116 further estimates the estimated captured image G3 (see FIG. 10) captured in a direction perpendicular to the support surface 26 (in this example, captured from above in the height direction Z), based on the plurality of identification marks M1 in the captured image G1. In addition to converting the orientation of the captured image G1 such that the plurality of identification marks M1 have the reference positional relationship P1 (see FIG. 9), the converter 116 converts the captured image G1 into the estimated captured image G3 and provides a converted captured image G2 shown in FIG. 10. In this example embodiment, in the case where, as shown in FIG. 9, an image of the support surface 26 is captured in a direction inclined with respect to the height direction Z (in this example, from a position to the right of, and above, the support surface 26), the frame border line L10 connecting the plurality of identification marks M1 is trapezoidal. As shown in FIG. 10, the estimated captured image G3 is an image of the support surface 26 as seen from above in the height direction Z, and the frame border line L10 forms a rectangular or substantially rectangular shape. The converter 116 converts the captured image G1 into the estimated captured image G3, such that the shape of the frame border line L10 connecting the plurality of identification marks M1 becomes a rectangular or substantially rectangular shape from the trapezoidal shape, and thus creates the converted captured image G2 shown in FIG. 10. In the case where the frame border line L10 is not provided on the support surface 26, the converter 116 may estimate a virtual frame border line connecting the plurality of identification marks M1 and generate the estimated captured image G3, in which the virtual frame border line forms a rectangular or substantially rectangular shape. A trapezoidal shape may be converted into a rectangular or substantially rectangular shape as described above by use of, for example, a technology of trapezoid correction. The converted captured image G2 in FIG. 10 created as a result of the conversion by the converter 116 is stored on the storage 110 in FIG. 5.

FIG. 11 shows the converted captured image G2 and the printing image G5 displayed in an overlapping manner. In the next display step S106 in FIG. 7, the converted captured image G2 is displayed as shown in FIG. 11. In this example embodiment, the display step S106 is realized by the display controller 118 (see FIG. 5) of the operational terminal 100. The display controller 118 displays the converted captured image G2 and the printing image G5, which shows contents to be printed on the printing target 5, in an overlapping manner. The printing image G5 is an example of a processing image, which shows contents of processing to be performed on the processing target. As shown in FIG. 5, the printing image G5 is stored on the storage 110 in advance. As shown in FIG. 11, the display controller 118 displays the converted captured image G2 and the printing image G5 in an overlapping manner, such that the printing image G5 is stacked on the converted captured image G2. The printing image G5 is to be printed on the printing target 5 captured as being included in the converted captured image G2. When being displayed, the printing image G5 may or may not overlap the printing target 5 in the converted captured image G2. As shown in FIG. 11, the printing image G5 may be displayed as being partially protruding outside the printing target 5 in the converted captured image G2.

There is no specific limitation on the screen on which the converted captured image G2 and the printing image G5 are displayed in an overlapping manner. In this example embodiment, the display controller 118 displays the converted captured image G2 and the printing image G5 in an overlapping manner on the screen 101 of the operational terminal 100.

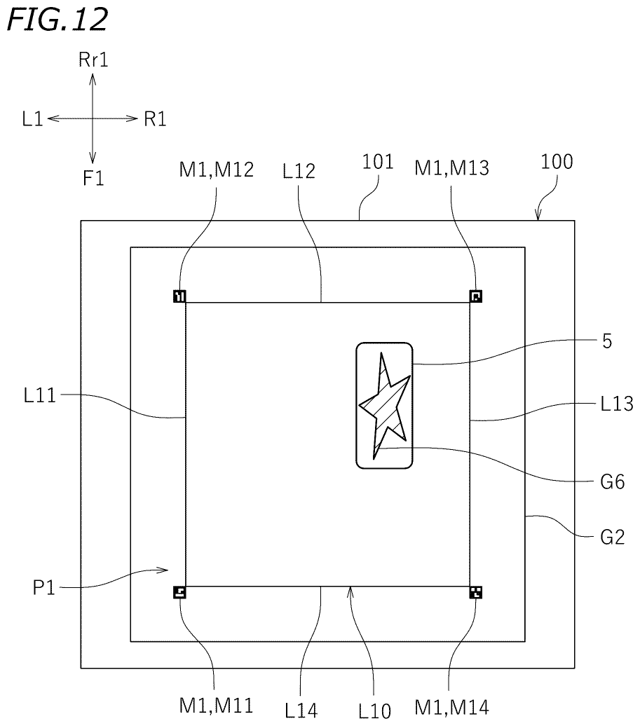

Next, in the adjustment step S107 in FIG. 7, the position, the orientation and the size of the printing image G5 are adjusted with respect to the printing target 5 in the converted captured image G2 (hereinafter, this process will also be referred to simply as “adjustment of the printing image G5). In this example embodiment, the adjustment step S107 is realized by the adjuster 120 (see FIG. 5) or the automatic adjuster 122 (see FIG. 5) of the operational terminal 100. In the adjustment step S107, the adjustment of the printing image G5 is performed manually or automatically. FIG. 12 shows the converted captured image G2 and an adjusted image G6 displayed in an overlapping manner. In the adjustment step S107, the post-adjustment image of the printing image G5 will be referred to as the “adjusted image G6” (see FIG. 12).

In this example, the adjuster 120 in FIG. 5 adjusts the printing image G5 manually based on a predetermined instruction. In this example, the “predetermined instruction” refers to, for example, an instruction made by the user operating the operation member 102 (see FIG. 5) of the operational terminal 100. For example, the screen 101 displays an adjustment screen having an adjustment function of adjusting the printing image G5. The user operates the operation member 102 to determine at least one of the position, the orientation and the size of the printing image G5 with respect to the printing target 5 on the adjustment screen. Based on an instruction regarding the position, the orientation or the size of the printing image G5 thus determined, the adjuster 120 adjusts the printing image G5 to create the adjusted image G6 shown in FIG. 12.

The automatic adjuster 122 in FIG. 5 adjusts the printing image G5 automatically. In this example, the automatic adjuster 122 automatically adjusts at least one of the position, the orientation and the size of the printing image G5 such that the adjusted image G6 corresponds to the printing target 5 in the converted captured image G2. The automatic adjuster 122 automatically adjusts the printing image G5 such that the printing image G5 does not protrude outside the printing target 5, and thus creates the adjusted image G6 shown in FIG. 12. In this example, the adjuster 120 adjusts the printing image G5 based on a predetermined instruction, and thus creates the adjusted image G6. The automatic adjuster 122 automatically adjusts the printing image G5, and thus creates the adjusted image G6. The adjusted image G6 created by the adjuster 120 or the automatic adjuster 122 is stored on the storage 110 in FIG. 5.

Next, in the generation step S108 in FIG. 7, printing data DT1 is generated. In this example embodiment, the generation step S108 is realized by the generator 124 (see FIG. 5) of the operational terminal 100. The generator 124 generates the data DT1 corresponding to the adjusted image G6. The printing data DT1 is an example of a processing data. In this example, the printing data DT1 is data generated as a result of the adjusted image G6 being converted into a form readable by the printer controller 60 of the printer 10. The adjusted image G6 is converted in order to be transmitted to the printer 10. The printing data DT1 is, for example, data of a raster format, that is, raster data. The adjusted image G6 is, for example, bitmap data. The generator 124 rasterizes the adjusted image G6 to generate the printing data DT1. The printing data DT1 generated by the generator 124 is stored on the storage 110 in FIG. 5.

In this example embodiment, after the printing data DT1 is generated, the printer 10 starts performing printing on the printing target 5. First, the printing data DT1 is transmitted from the terminal controller 103 of the operational terminal 100 to the printer 10. On the printer 10 side, the printer controller 60 receives the printing data DT1, and printing is performed on the printing target 5 supported by the support surface 26 based on the printing data DT1. The position of the printing target 5 with respect to the support surface 26 at this point is the position at which the printing target 5 is placed in the placing step S101 (regarding the position, see FIG. 6) described above.

Printing is performed on the printing target 5 as follows. While the ink heads 32 are reciprocated once above the support table 25 in the main scanning direction Y, the ink is ejected based on the printing data DT1 from the nozzles 33 toward the printing target 5 supported by the support surface 26. Thus, one scan of printing is finished. After the one reciprocation of the ink heads 32, the support table 25 is moved in the sub scanning direction X by a predetermined distance. At this point, the printing target 5 supported by the support table 25 is also moved in the sub scanning direction X by the predetermined distance. Then, while the ink heads 32 are reciprocated once above the support table 25 in the main scanning direction Y, the ink is ejected from the nozzles 33. Thus, the next scan of printing is finished. In this example, one reciprocation of the ink heads 32 in the main scanning direction Y and the movement of the support table 25 in the sub scanning direction X are performed in repetition, so that printing of the adjusted image G6 on the printing target 5 based on the printing data DT1 is finished.

As described above, in this example embodiment, as shown in FIG. 1, the processing system 1 includes the printers 10 each as an example of a processing device, and the operational terminals 100. As shown in FIG. 3, the printer 10 includes the support table 25 including the support surface 26, which supports the printing target 5 as an example of a processing target. As shown in FIG. 6, the support surface 26 includes the plurality of identification marks M1, having the reference positional relationship P1, provided thereon. As shown in FIG. 1, each of the operational terminals 100 is communicably connected with the corresponding printer 10. As shown in FIG. 5, the terminal controller 103 of the operational terminal 100 is configured or programmed to include the acquirer 112, the identifier 114, the converter 116, and the display controller 118. In the acquisition step S103 in FIG. 7, the acquirer 112 acquires the captured image G1 (see FIG. 8) of the support surface 26, which is captured by the imaging device 150 so as to include the plurality of identification marks M1 and the printing target 5 supported by the support surface 26. In the identification step S104 in FIG. 7, the identifier 114 identifies the positions of the plurality of identification marks M1 with respect to the orientation of the captured image G1 acquired by the acquirer 112. In the conversion step S105 in FIG. 7, the converter 116 converts the orientation of the captured image G1 such that the positional relationship among the plurality of identification marks M1 in the captured image G1 (in this example, the captured positional relationship P2) becomes the reference positional relationship P1, and thus provides the converted captured image G2A (see FIG. 9). In the display step S106 in FIG. 7, as shown in FIG. 11, the display controller 118 displays the converted captured image G2 and the printing image G5 as an example of a processing image, showing contents of processing to be performed on the printing target 5, in an overlapping manner.

In this case, it may possibly occur that, for example, an image of the support surface 26 is captured by the imaging device 150 at any of various positions, any of various orientations and any of various angles with respect to the support surface 26 of the printer 10. In this example, the positions of the plurality of identification marks M1 with respect to the orientation of the captured image G1 are identified, and the orientation of the captured image G1 is converted such that the positional relationship among the plurality of identification marks M1 (in this example, the captured positional relationship P2) in the captured image G1 becomes the reference positional relationship P1. Thus, the converted captured image G2A (see FIG. 9) is created. Therefore, the positional relationship among the plurality of identification marks M1 in the converted captured image G2A is the reference positional relationship P1. As shown in FIG. 11, the converted captured image G2 and the printing image G5 are displayed in an overlapping manner, so that the printing target 5 supported by the support surface 26 is displayed with the position and the orientation thereof being properly identified. Therefore, the printing target 5 supported by the support surface 26 is properly displayed without the position or the orientation thereof depending on the position or the orientation of the imaging device 150 with respect to the support surface 26.

In this example embodiment, in the conversion step S105 in FIG. 7, the converter 116 converts the orientation of the captured image G1 such that the plurality of identification marks M1 has the reference positional relationship P1, and also estimates the estimated captured image G3 (see FIG. 10) captured in a direction perpendicular to the support surface 26 (in this example, captured from above in the height direction Z) based on the plurality of identification marks M1, and converts the captured image G1 into the estimated captured image G3 to provide the converted captured image G2 (see FIG. 10). As a result, the converted captured image G2 is set as the image of the support surface 26 as seen in the direction perpendicular to the support surface 26 (in this example, as seen from above in the height direction Z). Therefore, it is easily determined how the printing image G5 is to be printed on the printing target 5 as seen from above in the height direction Z.

In this example embodiment, as shown in FIG. 6, four identification marks M1 are provided, for example, as the plurality of identification marks M1, on the support surface 26 such that a line connecting the identification marks M1 forms a rectangular or substantially rectangular shape. In the conversion step S105 in FIG. 7, the converter 116 estimates the estimated captured image G3 (see FIG. 10) such that the line connecting the plurality of identification marks M1 in the captured image G1 forms a rectangular or substantially rectangular shape. In this manner, the captured image G1 is converted such that the line connecting the plurality of identification marks M1 in the captured image G1 forms a rectangular or substantially rectangular shape, so that the converted captured image G2 as seen from above in the height direction Z is created.

In this example embodiment, as shown in FIG. 5, the terminal controller 103 of the operational terminal 100 includes the adjustor 120. In the adjustment step S107 in FIG. 7, the adjuster 120 creates the adjusted image G6 (see FIG. 12) as a result of adjusting at least one of the position, the orientation and the size of the printing image G5, as an example of a processing image, for the printing target 5 in the converted captured image G2, based on a predetermined instruction from the user. In this manner, for example, the user makes a predetermined instruction such that at least one of the position, the orientation and the size of the printing image G5 is adjusted, so that the printing image G5 is fine-adjusted and thus the adjusted image G6 desired by the user is easily created.

In this example embodiment, as shown in FIG. 5, the terminal controller 103 of the operational terminal 100 is configured or programmed to include the automatic adjuster 122. In the adjustment step S107 in FIG. 7, the automatic adjuster 122 creates the adjusted image G6 as a result of automatically adjusting at least one of the position, the orientation and the size of the printing image G5 such that the adjusted image G6 corresponds to the printing target 5 in the converted captured image G2. In this manner, the adjusted image G6 is created by automatic adjustment on the printing image G5 with no instruction from the user. Therefore, the user does not need to use extra time or energy.

In this example embodiment, when the printing target 5 is to be placed on the support surface 26, the printing image G5 is adjusted to be contained within the printing target 5 on the screen 101 regardless of the orientation of the printing target 5. Therefore, printing is performed on the printing target 5 properly even when the printing target 5 is placed on the support surface 26 with no attention to the orientation of the printing target 5 with respect to the support surface 26.

In this example embodiment, as shown in FIG. 5, the terminal controller 103 of the operational terminal 100 is configured or programmed to include the generator 124. In the generation step S108 in FIG. 7, the generator 124 generates the printing data DT1 as an example of a processing data corresponding to the adjusted image G6. In this manner, the printing data DT1 corresponding to the adjusted image G6 is generated. Therefore, the adjusted image G6, created as a result of the printing image G5 being adjusted, is printed on the printing target 5.

In this example embodiment, as shown in FIG. 3, the support table 25 includes the carrying jig 130, which is placed on the support surface 26 and on which the printing target 5 is to be placed. As shown in FIG. 6, the plurality of identification marks M1 are provided on the carrying jig 130, and are provided indirectly on the support surface 26 via the carrying jig 130. In this manner, the plurality of identification marks M1 are provided on the support surface 26 by a simple method of placing the carrying jig 130, provided with the plurality of identification marks M1, on the support surface 26. In the case where the plurality of identification marks M1 do not need to be provided on the support surface 26, the carrying jig 130 may be detached from the support surface 26, so that the support surface 26 with no identification marks M1 is provided.

In this example embodiment, the support surface 26 includes the frame border line L10 connecting the plurality of identification marks M1 so as to enclose the printing range AR1 provided thereon. With such a configuration, the user places the printing target 5 on the support surface 26 such that the printing target 5 is located within the frame border line L10. As a result, the printing target 5 is located within the printing range AR1. Therefore, the user visually determines the printing range AR1 easily by checking the frame border line L10.

In this example embodiment, the imaging device 150 is not secured to the printer 10. Therefore, an image of the support surface 26 is captured by use of the imaging device 150 at any of various positions, any of various orientations and any of various angles with respect to the support surface 26, without the position of the imaging device 150 being fixed with respect to the support surface 26.

In this example embodiment, the plurality of identification marks M1 may be directly provided on the support surface 26. For example, the plurality of identification marks M1 may be directly printed on the support surface 26. This allows the plurality of identification marks M1 to be positionally fixed with respect to the support surface 26.

In this example embodiment, the printer 10 is an example of a processing device. The processing device is not limited to the printer 10. The processing device may be a so-called cutting device. The cutting device may include, for example, a cutting head including a cutter, and may cut a processing target by pressing the cutter onto the processing target. The cutting device may process the processing target in this manner.

The processing device may be a so-called hot stamping device. The hot stamping device includes a hot stamping head that stamps foil onto a processing target. The hot stamping device may stamp foil on the processing target with the hot stamping head, so that the foil is pasted on the processing target. The hot stamping device may process the processing target in this manner. Alternatively, the processing device may be a so-called engraving machine or a press marking machine. The engraving machine may engrave a surface of a processing target by use of a rotary tool or laser to process the processing target. The press marking machine may pressurize a plate for etching to process the processing target.

In this example embodiment, the processing device is the printer 10, and the processing data is data of the raster format readable by the printer controller 60 of the printer 10. The processing data is not limited to data of the raster format. The processing data may be data of a format corresponding to the type of the processing device, that is, data of a format readable by a controller of the processing device. In the case where, for example, the processing device is a cutting device, the processing data may be of a vector format. The generator 124 converts the adjusted image G6 into a format readable by the controller of the processing device to generate the processing data.

In this example embodiment, the processing system 1 includes the printer 10 as an example of a processing device and the operational terminal 100. The controller is realized by the terminal controller 103 of the operational terminal 100. Alternatively, each of the elements of the terminal controller 103 of the operational terminal 100 may be included in the processing device. For example, the controller may be realized by the printer controller 60 of the printer 10 (in other words, the controller of the processing device). In this case, in the display step S106 in FIG. 7, the display controller 118 may display the converted captured image G2 and the printing image G5 in an overlapping manner on the display screen 21 of the printer 10 (in other words, the processing device). As can be seen, the controller may be realized by the terminal controller 103 of the operational terminal 100, which is separate from the printer 10 as an example of a processing device, or may be realized by the printer controller 60 integral with the printer 10. As can be seen from the above, the controller may be integral with the processing device or separate from the processing device. Each of the elements of the controller, that is, each of the elements of the terminal controller 103 may be included in a server communicably connected with the processing device and the imaging device 150.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A processing system, comprising:
a processing device including a support table with a support surface to support a processing target and including a plurality of identification marks with a reference positional relationship; and
a controller; wherein
the controller is configured or programmed to execute operations of:
an acquirer to acquire a captured image of the support surface captured by an imaging device and including the plurality of identification marks and the processing target supported by the support surface;
an identifier to identify positions of the plurality of identification marks in an orientation of the captured image acquired by the acquirer;
a converter to convert the orientation of the captured image such that a positional relationship among the plurality of identification marks in the captured image becomes the reference positional relationship to provide a converted captured image; and
a display controller to display the converted captured image and a processing image showing contents of processing to be performed on the processing target in an overlapping manner.

2. The processing system according to claim 1, wherein the converter is also configured or programmed to estimate an estimated captured image captured in a direction perpendicular or substantially perpendicular to the support surface based on the plurality of identification marks, and convert the captured image into the estimated captured image to provide the converted captured image.

3. The processing system according to claim 2, wherein
the plurality of identification marks include four identification marks defining a rectangular or substantially rectangular shape in a state of being connected with each other by a line; and
the converter is configured or programmed to estimate the estimated captured image such that the plurality of identification marks of the captured image define a rectangular or substantially rectangular shape in a state of being connected with each other by a line.

4. The processing system according to claim 1, wherein the controller is configured or programmed to execute an operation of an adjuster to create an adjusted image as a result of adjusting at least one of a position, an orientation and a size of the processing image for the processing target in the converted captured image based on an instruction from a user.

5. The processing system according to claim 1, wherein the controller is configured or programmed to execute an operation of an automatic adjuster to create an adjusted image as a result of automatically adjusting at least one of a position, an orientation and a size of the processing image such that the adjusted image corresponds to the processing target in the converted captured image.

6. The processing system according to claim 4, wherein the controller is configured or programmed to execute an operation of a generator to generate processing data corresponding to the adjusted image.

7. The processing system according to claim 1, wherein
the support table includes a carrying jig on the support surface to carry the processing target; and
the plurality of identification marks are provided on the carrying jig and are indirectly provided on the support surface via the carrying jig.

8. The processing system according to claim 1, wherein the plurality of identification marks are directly provided on the support surface.

9. The processing system according to claim 1, wherein the imaging device is not secured to the processing device.

10. A display method, comprising:
an image capturing step of capturing an image of a support surface of a support table included in a processing device, the support surface including a plurality of identification marks with a reference positional relationship and capable of supporting a processing target, the image including the plurality of identification marks and the processing target supported by the support surface;
an acquisition step of acquiring a captured image captured in the image capturing step;
an identification step of identifying positions of the plurality of identification marks in an orientation of the captured image acquired in the acquisition step;
a conversion step of converting the orientation of the captured image such that a positional relationship among the plurality of identification marks in the captured image becomes the reference positional relationship to provide a converted captured image; and
a display step of displaying the converted captured image and a processing image showing contents of processing to be performed on the processing target in an overlapping manner.
